(19) United States
(12) Patent Application Publication
(10) Pub. No.: US 2026/0010297 A1
(43) Pub. Date: Jan. 8, 2026

(54) MEMORY PAGE TYPE INDICATIONS FOR DATA INTEGRITY EVALUATIONS

(71) Applicant: Micron Technology, Inc., Boise, ID (US)

(72) Inventors: Deping He, Boise, ID (US); Caixia Yang, Boise, ID (US); Jie Zhou, Shanghai (CN)

(21) Appl. No.: 19/258,727

(22) Filed: Jul. 2, 2025

Related U.S. Application Data
(60) Provisional application No. 63/668,718, filed on Jul. 8, 2024.

(51) Int. Cl. G06F 3/06

(52) U.S. Cl. CPC G06F 3/0619; G06F 3/0644; G06F 3/0659; G06F 3/0673

(57) ABSTRACT

Methods, systems, and devices for memory page type indications for data integrity evaluations are described. A memory system may verify a page type corresponding to read data. For example, the memory system may store an indication of a page type corresponding to data written to memory cells as one or more bits of the data. During a read operation, the memory system may compare the stored indication of the page type to a second indication of a page type for data intended to be read. For example, the first indication read from the memory cells may correspond to a first page type, and the second indication (e.g., from an address mapping table, from metadata) may indicate a second page type. If the first and second indications are different, the memory system may refrain from outputting the data and may instead indicate an error or perform a second read operation.

### CROSS REFERENCE

The present Application for Patent claims priority to U.S. Patent Application No. 63/668,718 by He et al., entitled “MEMORY PAGE TYPE INDICATIONS FOR DATA INTEGRITY EVALUATIONS,” filed Jul. 8, 2024, which is assigned to the assignee hereof, and which is expressly incorporated by reference in its entirety herein.

### TECHNICAL FIELD

The following relates to one or more systems for memory, including page type indications for data integrity evaluations.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports page type indications for data integrity evaluations in accordance with examples as disclosed herein.

FIGS. 2A, 2B, 3A, and 3B show examples of distribution diagrams that support page type indications for data integrity evaluations in accordance with examples as disclosed herein.

FIG. 4 shows a block diagram of a memory system that supports page type indications for data integrity evaluations in accordance with examples as disclosed herein.

FIG. 5 shows a flowchart illustrating a method or methods that support page type indications for data integrity evaluations in accordance with examples as disclosed herein.

### DETAILED DESCRIPTION

Some memory systems may implement memory cells that may each store multiple bits of information, which may provide a greater density of storage relative to other types of memory cells (e.g., single-level cells (SLCs)). To read bits stored at a memory cell, one or more reference voltages (e.g., read voltages, voltage thresholds) may be applied to a memory cell to evaluate a response of the memory cell (e.g., to evaluate whether a read voltage is above or below a threshold voltage of the memory cell, to evaluate whether current flows through the memory cell when applying a reference voltage), or may be compared with a voltage of associated with a signal output from a memory cell, among other techniques. In some examples, voltage distributions (e.g., a threshold voltage distributions, distributions of threshold voltages, distributions of activation voltages) for different logic states of memory cells may be affected by conditions experienced by the memory system. For example, a memory system may experience a change in temperature between write operations and read operations (e.g., a cross-temperature phenomenon), or other state change (e.g., charge leakage), that causes threshold voltage distributions to change over time (e.g., to shift, relative to one or more reference voltages). Such changes in conditions of a memory system may lead to errors during a memory cell read operation. For example, applying reference voltages in a read operation to memory cells having shifted threshold voltage distributions may output incorrect data or cause processing operations (e.g., decoding operations, descrambling operations) to fail. In some cases, however, threshold voltage distributions may be shifted, but one or more processing operations may still succeed (e.g., due to reading cells in accordance with a different write configuration than intended), which may cause the memory system to output incorrect data (e.g., instead of outputting an error indication).

In accordance with examples as described herein, a memory system may verify a write configuration, such as a page type, corresponding to data read from a set of memory cells. For example, the memory system may store an indication (e.g., one or more bits) of a page type (e.g., between a lower page, an upper page, an extra page) corresponding to data written to one or more memory cells as one or more bits of the data. During a read operation, the memory system may compare the stored indication of the page type to a second indication of a page type (e.g., stored at different memory cells, stored with an address mapping). For example, in cases where the voltage distribution for the memory cells is shifted, the first indication may correspond to a first page type, while the stored indication for the data intended to be read may indicate a second page type. When a comparison indicates different page types between data as written and data as read, which may be indicative of erroneous read data (e.g., due to a shift in threshold voltage distributions), the memory system may refrain from outputting the read data and may instead issue an error indication. Additionally, or alternatively, the memory system may perform a corrective action, such as adjusting the one or more reference voltages, and attempting a second read operation with the adjusted reference voltages.

In addition to applicability in memory systems as described herein, techniques for storing a page type indication may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving evaluation of read data in response to changes in retention conditions (e.g., temperature differences between write and read operations, changes in stored charge, changes in state distributions among logic states), which may improve data integrity and reduce read errors during such changes in the retention conditions, among other benefits.

Features of the disclosure are illustrated and described in the context of systems, devices, and circuits. Features of the disclosure are further illustrated and described in the context of distribution diagrams and flowcharts.

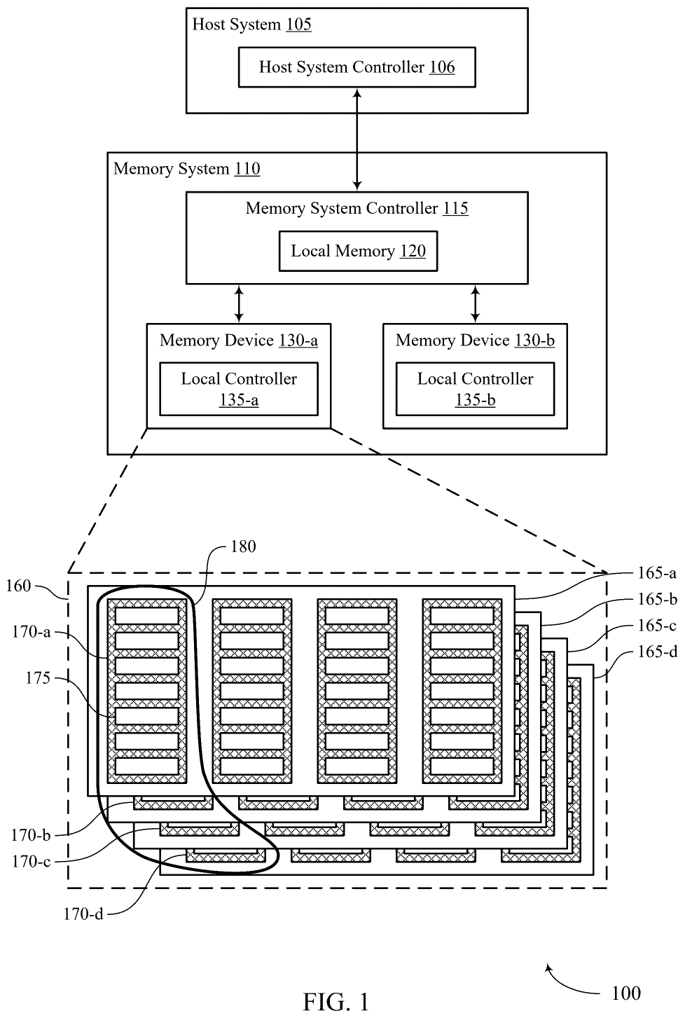

FIG. 1 shows an example of a system 100 that supports page type indications for data integrity evaluations in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically crasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently crased (e.g., crased concurrently as part of a single crase operation). Further, in some cases, NAND memory cells may be erased before they can be re-written with new data. Thus, for example, a used page 175 may, in some cases, not be updated until the entire block 170 that includes the page 175 has been crased.

For implementations in which memory cells of one or more dies 160 (e.g., of one or more memory devices 130) are configured to each store multiple bits of information (e.g., MLCs, TLCs, QLCs), the memory system 110 (e.g., the one or more memory devices 130) may be configured with a set of reference voltages (e.g., read voltages) used to distinguish between states (e.g., physical states, threshold voltage states, charge states) of the memory cells that each correspond to a different combination of multiple bit values. In some examples, voltage distributions (e.g., a threshold voltage distributions, distributions of threshold voltages, distributions of activation voltages) for different states of memory cells (e.g., different physical states that correspond to respective combinations of multiple bit values) may be affected by conditions experienced by a memory system 110. For example, a memory system 110 may experience a change in temperature between write operations and read operations (e.g., a cross-temperature phenomenon), or other state change (e.g., state shift, state degradation, charge leakage), that causes threshold voltage distributions to change over time (e.g., relative to one or more reference voltages). Such changes in conditions of a memory system 110 may lead to errors during a memory cell read operation. For example, applying reference voltages in a read operation to memory cells having shifted threshold voltage distributions may output incorrect data or cause processing operations (e.g., decoding operations, descrambling operations) to fail. In some cases, however, threshold voltage distributions may be shifted, but one or more processing operations may still succeed (e.g., due to reading cells in accordance with a different write configuration than intended), which may cause at least a portion of the memory system 110 (e.g., a memory device 130) to output incorrect data (e.g., instead of outputting an error indication).

In accordance with examples as described herein, a memory system 110, or a portion thereof (e.g., a memory device 130) may verify a write configuration, such as a page type, corresponding to data read from a set of memory cells (e.g., of one or more dies 160). For example, the memory system 110 (e.g., a memory system controller 115, a local controller 135) may store an indication (e.g., one or more bits) of a page type (e.g., between a lower page, an upper page, an extra page) corresponding to data written to one or more memory cells as one or more bits of the data. During a read operation, the memory system 110 (e.g., a memory system controller 115, a local controller 135) may compare the stored indication of the page type to a second indication of a page type (e.g., stored with an address mapping, stored in local memory 120, stored in different memory cells of a same memory device 130, stored in memory cells of a different memory device 130). For example, in cases where the voltage distribution for the memory cells is shifted, the first indication may correspond to a first page type, while the stored indication for the data intended to be read may indicate a second page type. When a comparison indicates different page types between data as written and data as read, which may be indicative of erroneous read data (e.g., due to a shift in threshold voltage distributions), the memory system 110 (e.g., a memory system controller 115, a local controller 135) may refrain from outputting the read data and may instead issue an error indication. Additionally, or alternatively, the memory system 110 (e.g., the memory system controller 115, the local controller 135) may perform a corrective action, such as adjusting the one or more reference voltages, and attempting a second read operation with the adjusted reference voltages.

The system 100 may include any quantity of non-transitory computer readable media that support page type indications for data integrity evaluations. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein, such as those functions relating to page type indications for data integrity.

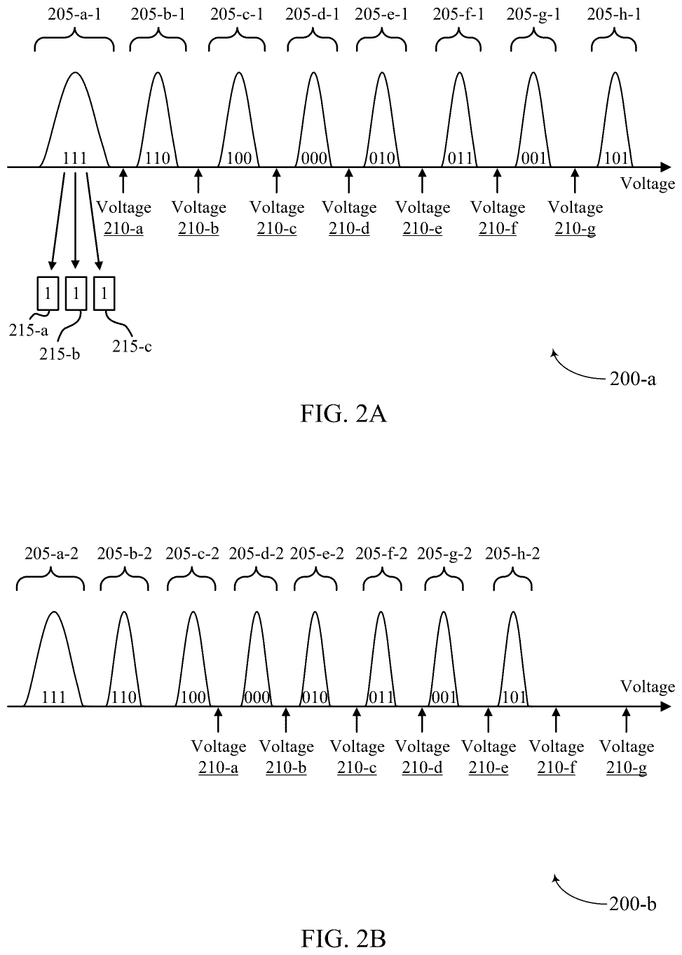

FIGS. 2A and 2B show examples of a distribution diagram 200-a and a distribution diagram 200-b that support page type indications for data integrity evaluations in accordance with examples as disclosed herein. The distribution diagrams 200 may be implemented by a memory system 110, as described herein. For example, a memory system 110 (e.g., one or more memory devices 130) may include one or more arrays of memory cells (e.g., NAND memory cells) having states as illustrated by the distribution diagrams 200, each state corresponding to a set of bit values stored by a respective memory cell. Although FIG. 2A and FIG. 2B illustrate distribution diagrams 200 for memory cells configured to each store three bit values (e.g., operated as TLCs), the described techniques may be applied with memory cells (e.g., different memory cells, different configurations of the same memory cells) configured to store different quantities of bit values (e.g., MLCs, QLCs, and others).

The distribution diagram 200-a illustrates a set of curves 205 (e.g., curves 205-a-1, 205-b-1, 205-c-1, 205-d-1, 205-e-1, 205-f-1, 205-g-1, and 205-h-1), and each curve 205 may correspond to a statistical distribution of voltages (e.g., threshold voltages, signal voltages) associated with a population of memory cells written with a given state (e.g., a three-bit logic state). A state associated with each curve 205 may correspond to a respective set of multiple bit values (e.g., a respective bit value for each of multiple bit positions). For example, the curve 205-a-1 may correspond to a first state stored by memory cells, which may correspond to bit values of 111, the curve 205-b-1 may correspond to a second state stored by memory cells, which may correspond to bit values of 110, and so on.

The memory system 110 may be configured with a set of voltages 210 (e.g., reference voltages, read voltages, read offsets, demarcation voltages, gate voltages), which may be applied to memory cells or otherwise used during a read operation by a memory system 110 (e.g., a memory device 130) to determine states written to memory cells. For example, the memory system 110 (e.g., a memory system controller 115, a local controller 135) may control application of one or more of the set of voltages 210 to memory cells being read (e.g., gates of a transistor), and the memory system 110 may determine one or more bit values stored by the memory cell based on (e.g., in response to, in accordance with) whether the threshold voltage of the memory cell is larger or smaller than the applied voltage 210 (e.g., based on a presence or absence of current flow through the memory while applying the voltage 210). In some examples, such as if each memory cell stores multiple bit values, the memory system 110 may apply multiple voltages 210 (e.g., via a memory system controller 115, a local controller 135, or a combination thereof) to determine one or more of the bit values stored by a memory cell.

In some implementations, each of the multiple bits (e.g., bit positions) stored by a memory cell may correspond to a respective write configuration (e.g., a page type), such that a single memory cell may store data associated with multiple pages. For example, a single page 175 (e.g., a single physical page) may be divided into multiple logical pages (e.g., multiple write configurations), such that a single physical page may be mapped with different logical addresses (e.g., different logical page addresses, different LBAs). For example, a bit position 215-a for a memory cell may correspond to a first page type (e.g., an extra page), a bit position 215-b for the memory cell may correspond to a second page type (e.g., an upper page), and a bit position 215-c for the memory cell may correspond to a third page type (e.g., a lower page). As such, memory cells written with a state corresponding to the curve 205-c-1, for example, may store a bit value of ‘1’ for the first page type (e.g., for the bit position 215-a), a bit value of ‘0’ for the second page type (e.g., for the bit position 215-b), and a bit value of ‘0’ for the third page type (e.g., for the bit position 215-c). Similarly, memory cells written with a state corresponding to the curve 205-e-1 may store a bit value of ‘0’ for the first page type, a bit value of ‘1’ for the second page type, and a bit value of ‘0’ for the third page type, and so on.

To perform a read operation for a given write configuration (e.g., for a given page type), the memory system 110 (e.g., a memory system controller 115, a local controller 135) may control application of voltages 210 based on (e.g., in accordance with) the targeted write configuration, or portion thereof (e.g., voltages 210 associated with distinguishing between bit values for a given bit position 215). In an illustrative example, to read memory cells (e.g., of a page 175) in accordance with the first page type (e.g., for bit position 215-a), a read operation may involve application of the voltage 210-c and the voltage 210-g (e.g., in one or more operations) to determine values for bit positions 215-a. For example, when reading the first page type, the memory system 110 may determine that memory cells having a threshold voltage lower than the voltage 210-c or higher than the voltage 210-g may be storing a value of ‘1’ for the bit position 215-a, and may determine that memory cells having a threshold voltage between the voltage 210-c and the voltage 210-g may be storing a value of ‘0’ for the bit position 215-a.

In another illustrative example, to read memory cells in accordance with the third page type (e.g., for bit position 215-c), a read operation may involve application of the voltage 210-a and the voltage 210-e (e.g., in one or more operations) to determine values for bit positions 215-c. For example, when reading the third page type, the memory system 110 may determine that memory cells having a threshold voltage lower than the voltage 210-a or higher than the voltage 210-e may be storing a value of ‘1’ for the bit position 215-c, and may determine that memory cells having a threshold voltage between the voltage 210-a and the voltage 210-e may be storing a value of ‘0’ for the bit position 215-c.

In another illustrative example, where applicable, to read memory cells in accordance with the second page type (e.g., for bit position 215-b), a read operation may involve application of the voltage 210-b, the voltage 210-d, and the voltage 210-f (e.g., in one or more operations) to determine values for bit positions 215-b. For example, when reading the third page type, the memory system 110 may determine that memory cells having a threshold voltage lower than the voltage 210-b or between the voltages 210-d and 210-f may be storing a value of ‘1’ for the bit position 215-b, and may determine that memory cells having a threshold voltage between the voltage 210-b and 210-d or greater than the voltage 210-f may be storing a value of ‘0’ for the bit position 215-b.

In some examples, a threshold voltage or other characteristic of a memory cell may vary depending on a write condition associated with writing to the memory cell. For example, a temperature of the memory system 110, or a portion thereof (e.g., of the memory cell, of the memory device 130), a voltage supplied to the memory system 110, or other conditions experienced by the memory system 110 at a time of performing the write operation may affect the stored charge or threshold voltage of the written memory cell. Additionally, or alternatively, a threshold voltage or other characteristic may change over time (e.g., due to charge leakage, due to changes in threshold characteristics), or a voltage condition may change (e.g., a supply voltage may change, a voltage as regulated at the memory system 110 may change). Based on these and other phenomena, the threshold voltages corresponding to memory cells may change, such as in accordance with the curves 205 of the distribution diagram 200-b, which may be different than (e.g., shifted relative to) the curves 205 of the distribution diagram 200-a (e.g., for the same states, for the same logic states). Accordingly, voltages 210 may no longer be aligned between intended curves 205, which may degrade an ability for a memory system 110 to distinguish between states.

In some cases, the memory system 110 may apply incorrect voltages 210 while performing a read operation (e.g., voltages 210 that may or may not be aligned between expected curves 205). For example, the memory system 110 may experience an error condition (e.g., a firmware bug, an abnormal read error recovery), or may have applied incorrect values for the set of voltages 210 (e.g., after a re-initialization, during a recovery procedure, due to a shift in curves 205, due an unresolved cross-temperature condition). In some examples, this may result in a read error, for example, as decoding performed by the memory system 110 (e.g., low-density parity check (LDPC) decoding) on the read data using the incorrect voltages 210 may be unsuccessful. However, in some cases, decoding (e.g., LPDC decoding) may succeed, which may be based on reading in incorrect write configuration (e.g., an incorrect page type, an incorrect bit position of the multi-level cells).

In an illustrative example, a memory system 110 may attempt to read memory cells (e.g., a page 175) in accordance with the third page type by applying the voltage 210-a and the voltage 210-c. However, as shown in the distribution diagram 200-b, the voltage 210-a may not be aligned between curves 205-a-2 and 205-b-2, and the voltage 210-f may not be aligned between curves 205-f-2 and 205-g-2, and thus may not be able to accurately distinguish between the respective states to read the third page type. However, although the memory system 110 may apply incorrect values for the third page type, the data read by the memory system 110 may still be valid data, but corresponding to a different page type (e.g., the first page type, associated with a different logical block address). For example, the voltages 210-a and 210-e as applied in accordance with the shifted distribution diagram 200-b may coincidentally operate similarly to voltages 210-c and 210-g in accordance with the distribution diagram 200-a. Thus, when performing a read operation on memory cells with shifted threshold voltage distributions, an attempt to read memory cells in accordance with the third page type may inadvertently output read data in accordance with the first page type. When reading such data of an inadvertently different page type, the data itself may be valid, and a decoding operation or parity check operation (e.g., LPDC decoding) performed by the memory system 110 may succeed (e.g., in a false positive scenario). In some cases, such as if the memory system 110 does not have a logical block address that corresponds to the data intended to be read (e.g., such as in read operations associated with a recovery procedure, or corresponding to internal operations of the memory system 110), the memory system 110 may output the data (e.g., to a host system 105, to a component of the memory system 110), which may lead to the wrong data being output, data integrity issues, and other problems.

In accordance with examples as described herein, the memory system 110 (e.g., a memory system controller 115, one or more local controllers 135) may store an indication (e.g., one or more bits) of a write configuration, such as a page type (e.g., an indication of whether data was written with a first page type, a second page type, or a third page type) corresponding to a set of data written to a set of memory cells (e.g., to a page 175) as part of the set of data (e.g., as one or more bits). During a read operation for the data, the memory system 110 may compare the indication of the page type stored with and read with the data (e.g., at the page 175) to a second indication (e.g., stored at a different set of memory cells, stored with an L2P mapping or other metadata associated with the set of data). By performing such a comparison, the memory system 110 may evaluate whether a set of data is valid (e.g., corresponding to an intended page type), and may avoid outputting invalid data.

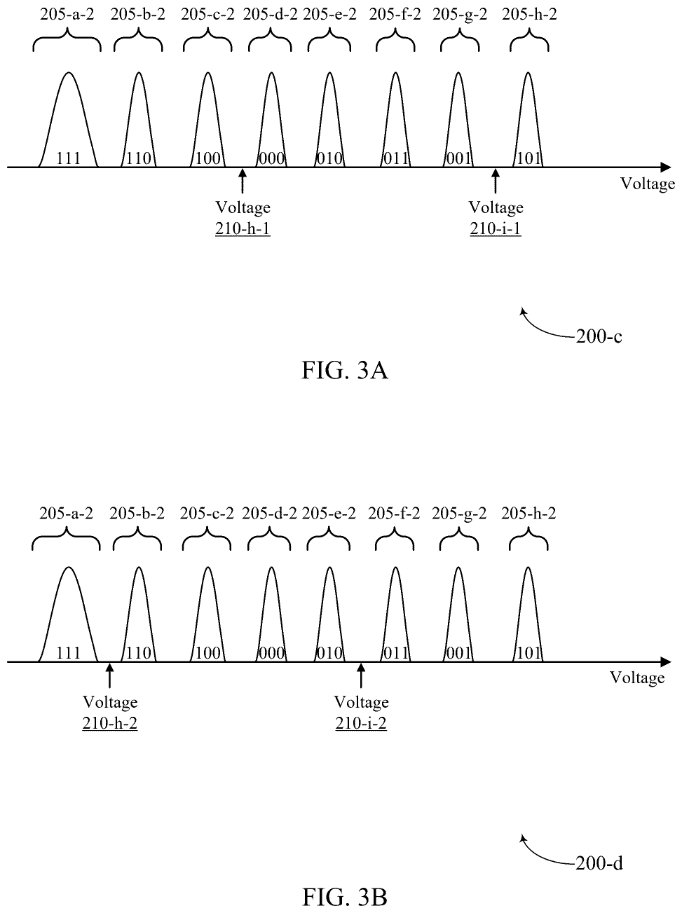

FIGS. 3A and 3B show examples of a distribution diagram 200-c and a distribution diagram 200-d that support page type indications for data integrity evaluations in accordance with examples as disclosed herein. Although FIGS. 3A and 3B illustrate distribution diagrams 200 for memory cells configured to each store three bit values, the described techniques may be applied with memory cells configured to store different quantities of bit values.

In accordance with the described techniques, a memory system 110 may store an indication of a write configuration for data written to memory cells. For example, the memory system 110 (e.g., via a memory system controller 115, one or more local controllers 135) may write data to a first set of memory cells (e.g., of a page 175) in accordance with the write configuration and store an indication of the write configuration (e.g., as one bit or multiple bits) that accompanies the data (e.g., as metadata). In an illustrative example, at least a portion of a page 175 may be written with bit values of a page type (e.g., of a bit position 215) in a format that includes user data along with an indication of the page type and, in some examples, other information, such as, in some examples, one or more bits of a scrambler seed, an indication of a logical address (e.g., metadata, an LBA), CRC bits, parity bits, among other metadata. The memory system 110 may also write another indication of the write configuration (e.g., page type) to another location, such as in another set of memory cells (e.g., at a table for storing the second indications, of a same memory device 130, of a different memory device 130, of local memory 120), or with an address mapping associated with the data (e.g., as an entry at a mapping table, such as an L2P mapping). In some examples, the indications of a write configuration may be an indication of a page type (e.g., a logical page, selected between an extra page type, an upper page type, or a lower page type) associated with a page 175 (e.g., a physical page) at which the data was written, which may correspond to a subset of bits (e.g., one bit) of a set of bits stored by each memory cell. In some examples, an indication of a page type may be one bit which may indicate whether the corresponding page 175 has a lower page type or a middle page type. In some other examples, an indication of a page type may be multiple bits that may differentiate between additional page types.

A memory system 110 (e.g., a memory system controller 115, a local controller 135) may initiate a read operation to read the data from the first set of memory cells. The memory system 110 may apply a set of voltages 210 (e.g., reference voltages, read voltages), such as a voltage 210-h-1 and a voltage 210-i-1. In some cases, however, the voltage distribution for the first set of memory cells may be altered due to conditions of the memory system 110 (e.g., changes in temperature, voltages, or other conditions) experienced since the data was written to the first set of memory cells. Additionally, or alternatively, the memory system 110 may use incorrect values for the voltages 210, for example, due to a firmware error, or due to a different initialization of values (e.g., after a recovery operation due to system shut down). As such, the read operation may result in reading a first set of data that is different than the data intended to be read by the memory system 110. For example, the first read data may correspond to data written with a different page type (e.g., stored at the same set of memory cells that each store multiple bit values corresponding to multiple page types).

In some examples, the memory system 110 may perform a decoding for the first set of data. For example, the memory system 110 may perform one or more parity check operations, such as LPDC decoding, which may involve using a sparse parity-check matrix for detecting errors in the data. In some cases, the decoding for the first set of data may succeed, despite the first set of data being different than the data intended to be read by the memory system 110. For example, if the first set of data corresponds to a different page type (e.g., a different bit position 215), the decoding may succeed even if the first set of data was not the desired set of data.

In some examples, the memory system 110 may determine the set of data based on (e.g., in accordance with, after performing) a descrambling operation. For example, the memory system 110 may scramble data prior to writing the data to memory cells (e.g., by randomizing bits of the data), which may prevent errors or improve data security by, for instance, achieving a more even distribution of bit values for the data (e.g., avoiding large concentrations of a same bit value stored in adjacent locations). The memory system 110 may perform descrambling operation for the first set of data (e.g., after the decoding). In some examples, the descrambling may be performed based on a scrambler seed used for scrambling the data during a write operation, and an indication of the scrambler seed may be stored by the memory system 110 during the write operation.

In some cases, the memory system 110 may perform an evaluation (e.g., verification) of a logical address (e.g., an LBA) corresponding to the first set of data. For example, the memory system 110 may compare a logical address associated with a received read command with an indication of a logical address stored with the first set of data. In some cases, however, the memory system 110 may not have a logical address available to compare with the indication of the logical address stored as part of the first set of data. For example, the memory system 110 may not have a logical address available for some internal operations, or while performing an access command after or as part of a recovery procedure, in which case the read operations may proceed without such an evaluation.

The memory system 110 (e.g., a memory system controller 115, a local controller 135) may determine whether the first set of data read from the memory cells is valid based on (e.g., in response to, in accordance with) comparing a first indication of the write configuration of the memory cells with a second indication of the write configuration from the set of data (e.g., after the descrambling, the logical address evaluation, the decoding, or a combination thereof). For example, the first indication of the write configuration may correspond to a stored indication written by the memory system 110 (e.g., to a second set of memory cells, to an address mapping associated with the first set of data). The second indication of the write configuration may be determined based on reading the first set of data from the memory cells. For example, the second indication may correspond to the indication of the write configuration written to the page 175 (e.g., as one bit or a set of bits, in accordance with the indicated page type). In some cases, the comparison of the first and second indications of the write configuration may be based on a logical address (e.g., logical block address) not being available for the logical address evaluation.

In some examples, the memory system 110 may perform an operation based on (e.g., in response to, in accordance with) whether the first set of data is determined to be valid. For example, the memory system 110 may determine that the first set of data is not valid based on the comparison of the first indication of the write configuration and the second indication of the write configuration. For instance, the first indication of the write configuration (e.g., associated with the read command) may indicate that the intended page type for the read operation was the third page type, whereas the second indication of the write configuration (e.g., associated with the data read from the page 175) may indicate that the read date is associated with the first page type. As such, the memory system 110 may refrain from outputting the first set of data (e.g., in response to an access command), output an error indication, or both.

Additionally, or alternatively, the memory system 110 may perform a second read operation, based on determining that the first set of data is not valid, using a different set of voltages 210. For example, as illustrated by the distribution diagram 200-d, the memory system may perform a second read operation using a voltage 210-h-2 and a voltage 210-i-2 to read data in accordance with the third page type (e.g., the target page type for the read operation). In some cases, the memory system 110 may adjust the voltage 210-h and the voltage 210-i based on the determination that the first set of data is not valid, and the amount of adjustment may be based on the first indication of the write configuration, the second indication of the write configuration, or both.

In some examples, the memory system 110 may determine a second set of data based on the second read operation, and the memory system 110 may perform decoding (e.g., LPDC decoding), descrambling, logical address evaluation, or a combination thereof. The memory system 110 may then determine whether the second set of data is valid based on comparing the first indication of the write configuration (e.g., stored at the second set of memory cells, at an address mapping associated with the first set of data) with a third indication of a write configuration from the second set of data (e.g., as one or more bits of the second set of data). In some cases, the memory system 110 may determine that the second set of data is valid based on the first indication of the write configuration indicating a same write configuration (e.g., a same page type) as the third indication. As such, the memory system 110 may output the second set of data, for example, in response to an access command previously received.

Thus, in accordance with these and other examples, a memory system 110 may verify a write configuration, such as a page type, corresponding to data read from a set of memory cells. By confirming that read data aligns with the write configuration that was intended to be read, the memory system 110 may provide improved data integrity and improved robustness to conditions that may alter stored states in memory cells.

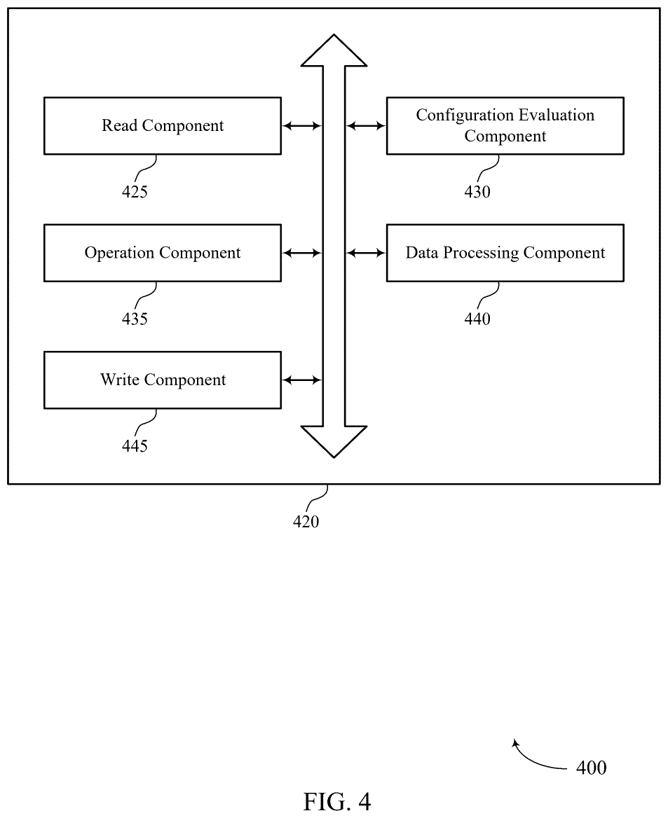

FIG. 4 shows a block diagram 400 of a memory system 420 that supports page type indications for data integrity evaluations in accordance with examples as disclosed herein. The memory system 420 may be an example of aspects of a memory system as described with reference to FIGS. 1 through 3. The memory system 420, or various components thereof, may be an example of means for performing various aspects of page type indications for data integrity evaluations as described herein. For example, the memory system 420 may include a read component 425, a configuration evaluation component 430, an operation component 435, a data processing component 440, a write component 445, or any combination thereof. Each of these components, or components of subcomponents thereof (e.g., one or more processors, one or more memories), may communicate, directly or indirectly, with one another (e.g., via one or more buses).

The read component 425 may be configured as or otherwise support a means for reading a set of data from a plurality of memory cells of a memory device of the memory system 420 in accordance with a plurality of reference voltages associated with a write configuration of the plurality of memory cells. The configuration evaluation component 430 may be configured as or otherwise support a means for determining whether the set of data is valid in response to comparing a first indication of the write configuration of the plurality of memory cells with a second indication from the set of data. The operation component 435 may be configured as or otherwise support a means for performing an operation of the memory system 420 in accordance with whether the set of data is determined to be valid.

In some examples, the second indication from the set of data is associated with a second indication of the write configuration of the plurality of memory cells written to the plurality of memory cells.

In some examples, the configuration evaluation component 430 may be configured as or otherwise support a means for determining the first indication of the write configuration from one or more second memory cells of the memory system 420.

In some examples, the configuration evaluation component 430 may be configured as or otherwise support a means for determining the first indication of the write configuration in accordance with an address mapping associated with the set of data. In some examples, the first indication of the write configuration is one of a plurality of first indications of a plurality of write configurations of the plurality of memory cells.

In some examples, the data processing component 440 may be configured as or otherwise support a means for determining the set of data in accordance with a descrambling operation after reading the plurality of memory cells, a decoding operation after reading the plurality of memory cells, a logical block address evaluation, or a combination thereof. In some examples, the configuration evaluation component 430 may be configured as or otherwise support a means for comparing the first indication of the write configuration with the second indication from the set of data after the descrambling operation, the decoding operation, the logical block address evaluation, or the combination thereof.

In some examples, the write component 445 may be configured as or otherwise support a means for writing to the plurality of memory cells in accordance with the write configuration, where the writing includes writing an indication equal to the first indication of the write configuration.

In some examples, to support performing the operation of the memory system 420, the read component 425 may be configured as or otherwise support a means for determining, in response to determining that the set of data is not valid, a second set of data after reading the plurality of memory cells in accordance with a plurality of second reference voltages. In some examples, to support performing the operation of the memory system 420, the configuration evaluation component 430 may be configured as or otherwise support a means for determining whether the second set of data is valid in response to comparing the first indication of the write configuration of the plurality of memory cells with a third indication from the second set of data. In some examples, to support performing the operation of the memory system 420, the operation component 435 may be configured as or otherwise support a means for outputting at least a portion of the second set of data in accordance with determining that the second set of data is valid.

In some examples, the operation component 435 may be configured as or otherwise support a means for receiving an access command, and performing the operation of the memory system 420 may include outputting user data of the set of data in response to the access command in response to determining that the set of data is valid.

In some examples, to support performing the operation of the memory system 420, the operation component 435 may be configured as or otherwise support a means for outputting an error indication in response to determining that the set of data is not valid.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor, such as a memory system controller 115, one or more local controllers 135, or a combination thereof.

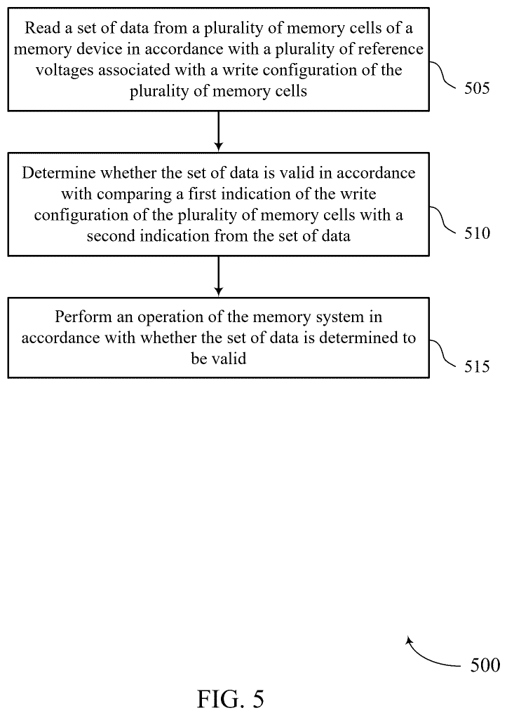

FIG. 5 shows a flowchart illustrating a method 500 that supports page type indications for data integrity evaluations in accordance with examples as disclosed herein. The operations of method 500 may be implemented by a memory system or its components as described herein. For example, the operations of method 500 may be performed by a memory system (e.g., including one or more memory devices) as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include reading a set of data from a plurality of memory cells of a memory device in accordance with a plurality of reference voltages associated with a write configuration of the plurality of memory cells. In some examples, aspects of the operations of 505 may be performed by a read component 425 as described with reference to FIG. 4.

At 510, the method may include determining whether the set of data is valid in response to comparing a first indication of the write configuration of the plurality of memory cells with a second indication from the set of data. In some examples, aspects of the operations of 510 may be performed by a configuration evaluation component 430 as described with reference to FIG. 4.

At 515, the method may include performing an operation of the memory system in accordance with whether the set of data is determined to be valid. In some examples, aspects of the operations of 515 may be performed by an operation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for reading a set of data from a plurality of memory cells of a memory device in accordance with a plurality of reference voltages associated with a write configuration of the plurality of memory cells; determining whether the set of data is valid in response to comparing a first indication of the write configuration of the plurality of memory cells with a second indication from the set of data; and performing an operation of the memory system in accordance with whether the set of data is determined to be valid.

Aspect 2: The method, apparatus, or non-transitory computer-readable medium of aspect 1, where the second indication from the set of data is associated with a second indication of the write configuration of the plurality of memory cells written to the plurality of memory cells.

Aspect 3: The method, apparatus, or non-transitory computer-readable medium of any of aspects 1 through 2, further including operations, features, circuitry, logic, means, or instructions, or any combination thereof for determining the first indication of the write configuration from one or more second memory cells of the memory system.

Aspect 4: The method, apparatus, or non-transitory computer-readable medium of any of aspects 1 through 2, further including operations, features, circuitry, logic, means, or instructions, or any combination thereof for determining the first indication of the write configuration in accordance with an address mapping associated with the set of data.

Aspect 5: The method, apparatus, or non-transitory computer-readable medium of any of aspects 1 through 4, where the first indication of the write configuration is one of a plurality of first indications of a plurality of write configurations of the plurality of memory cells.

Aspect 6: The method, apparatus, or non-transitory computer-readable medium of any of aspects 1 through 5, further including operations, features, circuitry, logic, means, or instructions, or any combination thereof for determining the set of data in accordance with a descrambling operation after reading the plurality of memory cells, a decoding operation after reading the plurality of memory cells, a logical block address evaluation, or a combination thereof and comparing the first indication of the write configuration with the second indication from the set of data after the descrambling operation, the decoding operation, the logical block address evaluation, or the combination thereof.

Aspect 7: The method, apparatus, or non-transitory computer-readable medium of any of aspects 1 through 6, further including operations, features, circuitry, logic, means, or instructions, or any combination thereof for writing to the plurality of memory cells in accordance with the write configuration, where the writing includes writing an indication equal to the first indication of the write configuration.

Aspect 8: The method, apparatus, or non-transitory computer-readable medium of any of aspects 1 through 7, where performing the operation of the memory system includes operations, features, circuitry, logic, means, or instructions, or any combination thereof for determining, in response to determining that the set of data is not valid, a second set of data after reading the plurality of memory cells in accordance with a plurality of second reference voltages; determining whether the second set of data is valid in response to comparing the first indication of the write configuration of the plurality of memory cells with a third indication from the second set of data; and outputting at least a portion of the second set of data in response to determining that the second set of data is valid.

Aspect 9: The method, apparatus, or non-transitory computer-readable medium of any of aspects 1 through 8, further including operations, features, circuitry, logic, means, or instructions, or any combination thereof for receiving an access command, where performing the operation of the memory system includes outputting user data of the set of data in response to the access command in response to determining that the set of data is valid.

Aspect 10: The method, apparatus, or non-transitory computer-readable medium of any of aspects 1 through 9, where performing the operation of the memory system includes operations, features, circuitry, logic, means, or instructions, or any combination thereof for outputting an error indication in response to determining that the set of data is not valid.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
read a set of data from a plurality of memory cells of a memory device of the one or more memory devices in accordance with a plurality of reference voltages associated with a write configuration of the plurality of memory cells;
determine whether the set of data is valid in response to comparing a first indication of the write configuration of the plurality of memory cells with a second indication from the set of data; and
perform an operation of the memory system in accordance with whether the set of data is determined to be valid.

2. The memory system of claim 1, wherein the second indication from the set of data is associated with a second indication of the write configuration of the plurality of memory cells written to the plurality of memory cells.

3. The memory system of claim 1, wherein the processing circuitry is further configured to cause the memory system to:
determine the first indication of the write configuration from one or more second memory cells of the memory system.

4. The memory system of claim 1, wherein the processing circuitry is further configured to cause the memory system to:
determine the first indication of the write configuration in accordance with an address mapping associated with the set of data.

5. The memory system of claim 1, wherein the first indication of the write configuration is one of a plurality of first indications of a plurality of write configurations of the plurality of memory cells.

6. The memory system of claim 1, wherein the processing circuitry is further configured to cause the memory system to:
determine the set of data in accordance with a descrambling operation after reading the plurality of memory cells, a decoding operation after reading the plurality of memory cells, a logical block address evaluation, or a combination thereof; and
compare the first indication of the write configuration with the second indication from the set of data after the descrambling operation, the decoding operation, the logical block address evaluation, or the combination thereof.

7. The memory system of claim 1, wherein the processing circuitry is further configured to cause the memory system to:
write to the plurality of memory cells in accordance with the write configuration, wherein the writing comprises writing an indication equal to the first indication of the write configuration.

8. The memory system of claim 1, wherein, to perform the operation of the memory system, the processing circuitry is configured to cause the memory system to:
determine, in response to determining that the set of data is not valid, a second set of data after reading the plurality of memory cells in accordance with a plurality of second reference voltages;
determine whether the second set of data is valid in response to comparing the first indication of the write configuration of the plurality of memory cells with a third indication from the second set of data; and
output at least a portion of the second set of data in response to determining that the second set of data is valid.

9. The memory system of claim 1, wherein the processing circuitry is further configured to cause the memory system to:
receive an access command, wherein performing the operation of the memory system comprises outputting user data of the set of data in response to the access command in response to determining that the set of data is valid.

10. The memory system of claim 1, wherein, to perform the operation of the memory system, the processing circuitry is configured to cause the memory system to:
output an error indication in response to determining that the set of data is not valid.

11. A non-transitory computer-readable medium storing code comprising instructions which, when executed by one or more processors of a memory system, cause the memory system to:
read a set of data from a plurality of memory cells of a memory device in accordance with a plurality of reference voltages associated with a write configuration of the plurality of memory cells;
determine whether the set of data is valid in response to comparing a first indication of the write configuration of the plurality of memory cells with a second indication from the set of data; and
perform an operation of a memory system in accordance with whether the set of data is determined to be valid.

12. The non-transitory computer-readable medium of claim 11, wherein the second indication from the set of data is associated with a second indication of the write configuration of the plurality of memory cells written to the plurality of memory cells.

13. The non-transitory computer-readable medium of claim 11, wherein the instructions, when executed by the one or more processors of the memory system, cause the memory system to:
determine the first indication of the write configuration from one or more second memory cells of the memory system.

14. The non-transitory computer-readable medium of claim 11, wherein the instructions, when executed by the one or more processors of the memory system, cause the memory system to:
determine the first indication of the write configuration in accordance with an address mapping associated with the set of data.

15. The non-transitory computer-readable medium of claim 11, wherein the first indication of the write configuration is one of a plurality of first indications of a plurality of write configurations of the plurality of memory cells.

16. The non-transitory computer-readable medium of claim 11, wherein the instructions, when executed by the one or more processors of the memory system, cause the memory system to:
determine the set of data in accordance with a descrambling operation after reading the plurality of memory cells, a decoding operation after reading the plurality of memory cells, a logical block address evaluation, or a combination thereof; and
compare the first indication of the write configuration with the second indication from the set of data after the descrambling operation, the decoding operation, the logical block address evaluation, or the combination thereof.

17. The non-transitory computer-readable medium of claim 11, wherein the instructions, when executed by the one or more processors of the memory system, cause the memory system to:
write to the plurality of memory cells in accordance with the write configuration, wherein the writing comprises writing an indication equal to the first indication of the write configuration.

18. The non-transitory computer-readable medium of claim 11, wherein the instructions to perform the operation of the memory system, when executed by the one or more processors of the memory system, cause the memory system to:
determine, in accordance with determining that the set of data is not valid, a second set of data after reading the plurality of memory cells in accordance with a plurality of second reference voltages;
determine whether the second set of data is valid in response to comparing the first indication of the write configuration of the plurality of memory cells with a third indication from the second set of data; and
output at least a portion of the second set of data in response to determining that the second set of data is valid.

19. The non-transitory computer-readable medium of claim 11, wherein the instructions, when executed by the one or more processors of the memory system, cause the memory system to:
receive an access command, wherein performing the operation of the memory system comprises outputting user data of the set of data in response to the access command in response to determining that the set of data is valid.

20. The non-transitory computer-readable medium of claim 11, wherein the instructions to perform the operation of the memory system, when executed by the one or more processors of the memory system, cause the memory system to:
output an error indication in response to determining that the set of data is not valid.

21. A method by a memory system, comprising:
reading a set of data from a plurality of memory cells of a memory device in accordance with a plurality of reference voltages associated with a write configuration of the plurality of memory cells;
determining whether the set of data is valid in response to comparing a first indication of the write configuration of the plurality of memory cells with a second indication from the set of data; and
performing an operation of the memory system in accordance with whether the set of data is determined to be valid.

22. The method of claim 21, wherein the second indication from the set of data is associated with a second indication of the write configuration of the plurality of memory cells written to the plurality of memory cells.
